(19) United States
(12) Patent Application Publication
(10) Pub. No.: US 2012/0202183 A1
(43) Pub. Date: Aug. 9, 2012

(54) Controlled Release Survey and Methods Thereof

(76) Inventors: David Meagor, Bristol (GB); Richard Forrest Lamb, Broomfield, CO (US)

(21) Appl. No.: 13/356,875

(22) Filed: Jan. 24, 2012

Related U.S. Application Data
(60) Provisional application No. 61/462,687, filed on Feb. 7, 2011.

(51) Int. Cl. G09B 3/00

(52) U.S. Cl. 434/322

(57) ABSTRACT

The present disclosure pertains to a computer-implemented method for presenting a survey session to survey respondents, the method having: triggering a start event, obtaining session information, storing the session information, transmitting the session information to a host server, determining whether a survey associated with the session information has been previously created, selecting a question set to present to the respondent, incorporating a question set into a question panel, presenting the question panel to the respondent in a controlled manner, selecting an answer to the question, creating an answered question, and storing the answered question as a survey result.

### CROSS-REFERENCE TO RELATED APPLICATION

This application claims the benefit of priority to U.S. Provisional Application No. 61/462,687, filed on Feb. 7, 2011, which is incorporated herein by reference in its entirety.

### BACKGROUND

As surveys evolved from the telephone, software was developed to allow for surveys to be conducted online via webpages or software applications. Existing techniques for conducting electronic surveys are inadequate and suffer from problems of respondent selection and low participation which together produce low quality feedback which may thereby cause the survey to be misleading and biased.

### SUMMARY OF THE INVENTION

The present disclosure pertains to a computer-implemented method for presenting a survey session to survey respondents, the method having: triggering a start event, obtaining, using a microprocessor, session information, storing, using a microprocessor, the session information, transmitting, using a microprocessor, the session information to a host server, determining, using a microprocessor, whether a survey associated with the session information has been previously created, selecting a question set to present to the respondent, incorporating, using a microprocessor, a question set into a question panel, presenting, using a microprocessor, the question panel to the respondent in a controlled manner, selecting an answer to the question, creating, using a microprocessor, an answered question, storing, using a microprocessor, the answered question as a survey result, continuing to present question panels until a panel closing event is triggered, continuing to select a question set until a session ending event is triggered, and continuing to trigger a start event until a survey ending event is triggered.

In another aspect, the computer implemented method has the steps of identifying, using a microprocessor, that a survey has not been previously created and creating, using a microprocessor, a survey.

In another aspect, the presenting the question panel is controlled dependent on a period of time the respondent remains on the survey host. In another aspect, the presenting the question panel is controlled dependent on a period of time that has transpired since the respondent triggered a start event. In another aspect, the presenting the question panel is controlled dependent on the amount of interaction by the respondent with the survey host. In another aspect, the selecting a question panel to present to the respondent is based on a predetermined sequence. In another aspect, the selecting a question panel to present to the respondent is based on random selection. In another aspect, the selecting a question panel to present to the respondent is based on a volume balancing sequence. In another aspect, the selecting a question panel to present to the respondent is based on quota selection.

In another aspect, the present disclosure pertains to an online survey system having: a memory storage for maintaining a database and a processing unit coupled to the memory storage, where the processor is configured to generate question panels having question sets, obtain session information, store session information, transmit the session information to a host server, determine whether a survey associated with the session information has been previously created, select a question set to present to the respondent, incorporate a question set into a question panel, present the question panel to the respondent in a controlled manner, create an answered question, and store the answered question as a survey result.

In another aspect, the presentation of the question panels to the respondent in a controlled manner is dependent on a period of time the respondent remains on the survey host. In another aspect, the presentation of the question panels to the respondent in a controlled manner is dependent on a period of time that has transpired since the respondent triggered a start event. In another aspect, the presentation of the question panels to the respondent in a controlled manner is dependent on the amount of interaction by the respondent with the survey host.

With those and other objects, advantages and features on the invention that may become hereinafter apparent, the nature of the invention may be more clearly understood by reference to the following detailed description of the invention, the appended claims, and the drawings attached hereto.

### BRIEF DESCRIPTION OF THE DRAWINGS

The accompanying drawings, which are incorporated herein and form part of the specification, illustrate various embodiments of the present invention and together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, where:

FIG. 1 is a block diagram of an electronic device according to an exemplary embodiment.

FIG. 2 is a block diagram providing a more detailed view of a survey according to an exemplary embodiment.

FIG. 3 is a block diagram providing a more detailed view of a question panel according to an exemplary embodiment.

FIG. 4 is an example of a question panel according to an exemplary embodiment.

FIG. 5 is an example of a question panel according to an exemplary embodiment.

FIG. 6 is a block diagram providing a more detailed view of storage according to an exemplary embodiment.

FIG. 7 is a flow chart of a process according to an exemplary embodiment.

### DETAILED DESCRIPTION

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

The present disclosure relates to systems and methods that allow for the creation of online surveys 200 in which surveys 200 are presented over a period of time to reduce the perceived and/or actual time and effort needed to complete the survey 200. By reducing the perceived and/or actual time and effort needed to complete the survey 200, it is more likely that a given survey 200 respondent will take the time to more accurately answer all of the survey 200 questions, thereby yielding a more complete and accurate data set.

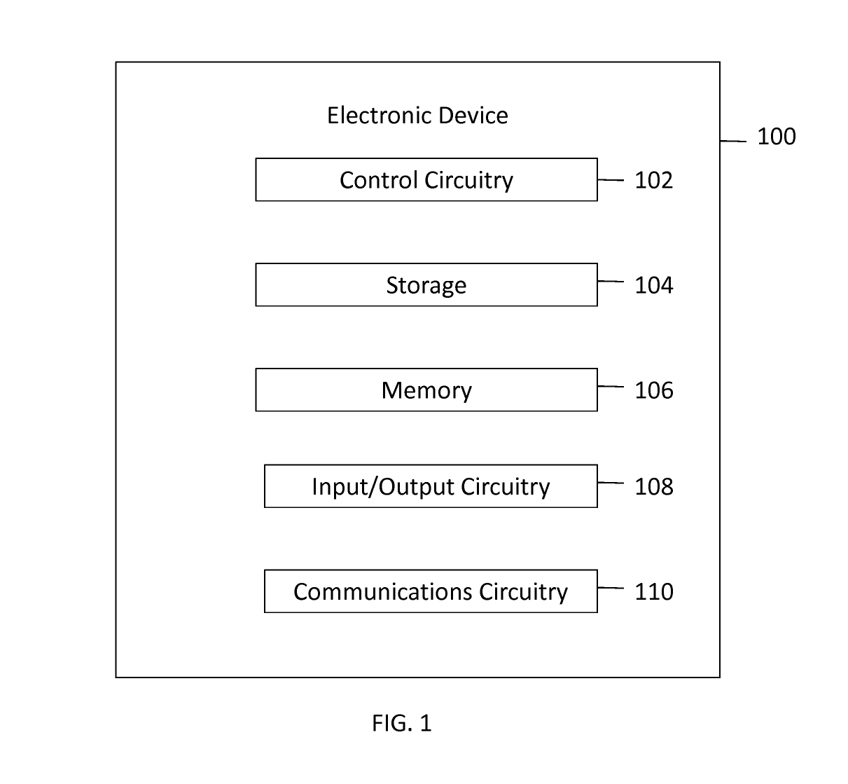

FIG. 1 shows an illustrative electronic device 100 for providing an application for interfacing with a host. Electronic device 100 can include control circuitry 102, storage 104, memory 106, input/output (“I/O”) circuitry 108, and communications circuitry 110. In some embodiments, one or more of the components of the electronic device 100 can be combined or omitted (e.g., storage 104 and memory 106 may be combined). In some embodiments, the electronic device 100 can include other components not combined or included in those shown in FIG. 1 (e.g., a display), or several instances of the components shown in FIG. 1. Only one of each of the components is shown in FIG. 1.

The electronic device 100 can include any suitable type of electronic device 100. For example, the electronic device 100 can include a substantially fixed electronic device 100, such as a desktop computer. As another example, electronic device 100 can include a larger portable electronic device 100, such as a laptop or tablet computer. As another example, the electronic device 100 can include a portable electronic device 100 that the respondent may hold in his or her hand, such as a digital media player, a personal e-mail device, a personal data assistant (“PDA”), a cellular telephone, a handheld gaming device, or a digital camera.

Control circuitry 102 can include any processing circuitry or unit including a microprocessor, or processor operative to control the operations and performance of the electronic device 100. For example, control circuitry 102 can be used to run operating system applications, firmware applications, media playback applications, media editing applications, or any other application. In some embodiments, control circuitry 102 can drive a display and process inputs received from an interface.

Storage 104 can include, for example, one or more storage 104 mediums including a hard-drive, solid state drive, flash memory, permanent memory such as ROM, any other suitable type of storage component, or any combination thereof. Storage 104 can store, for example, media data (e.g., music and video files), application data (e.g., for implementing functions on the electronic device 100), firmware, respondent preference information data (e.g., account information), authentication information (e.g. libraries of data associated with authorized respondents), wireless connection information data (e.g., information that can enable the electronic device 100 to establish a wireless connection), and any other suitable data or any combination thereof.

Memory 106 can include cache memory 106, semi-permanent memory such as RAM, and/or one or more different types of memory 106 used for temporarily storing data. In some embodiments, memory 106 can also be used for storing data used to operate electronic device 100 applications, or any other type of data that can be stored in storage 104. In some embodiments, memory 106 and storage 104 can be combined as a single storage 104 medium. In some embodiments, memory 106 and storage 104 are coupled to the processing unit.

I/O circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen), physical movements (e.g., from a mouse or sensor), analog audio signals (e.g., from a microphone), or any other input. The digital data can be provided to and received from control circuitry 102, storage 104, memory 106, or any other component of electronic device 100. Although I/O circuitry 108 is illustrated in FIG. 1 as a single component of electronic device 100, several instances of I/O circuitry 108 can be included in electronic device 100.

Electronic device 100 can include any suitable interface or component for allowing a respondent to provide inputs to I/O circuitry 108. For example, electronic device 100 can include any suitable input mechanism, for example, a button, keypad, mouse, dial, a click wheel, or a touch screen. In some embodiments, electronic device 100 can include a capacitive sensing mechanism, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or earbuds that can be coupled to communications device with a wire or wirelessly).

In some embodiments, I/O circuitry 108 can include display circuitry (e.g., a screen or projection system) for providing a display visible to the respondent. For example, the display circuitry can include a screen (e.g., an LCD screen) that is incorporated into electronic device 100. As another example, the display circuitry can include a movable display or a projecting system for providing a display of content on a surface remote from electronic device 100 (e.g., a video projector). In some embodiments, the display circuitry can include a coder/decoder (Codec) to convert digital media data into analog signals. For example, the display circuitry (or other appropriate circuitry within the electronic device 100) can include video Codecs, audio Codecs, or any other suitable type of Codec.

The display circuitry also can include display driver circuitry, circuitry for driving display drivers, or both. The display circuitry can be operative to display content (e.g., media playback information, application screens for applications implemented on the electronic device 100, information regarding ongoing communications operations, information regarding incoming communications requests, or device operation screens) under the direction of control circuitry 102. Alternatively, the display circuitry can be operative to provide instructions to a remote display.

Communications circuitry 110 can include any suitable communications circuitry 110 operative to connect to a communications network and to transmit communications (e.g., voice or data) from electronic device 100 to other devices within the communications network. Communications circuitry 110 can be operative to interface with the communications network using any suitable communications protocol such as, for example, Wi-Fi (e.g., a 802.11 protocol), Bluetooth®, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol.

In some embodiments, communications circuitry 110 can be operative to create a communications network using any suitable communications protocol. For example, communications circuitry 110 can create a short-range communications network using a short-range communications protocol to connect to other devices. For example, communications circuitry 110 can be operative to create a local communications network using the Bluetooth® protocol to couple electronic device 100 with a Bluetooth® headset.

Electronic device 100 can include one or more instances of communications circuitry 110 for simultaneously performing several communications operations using different communications networks, although only one is shown in FIG. 1. For example, electronic device 100 can include a first instance of communications circuitry 110 for communicating over a cellular network, and a second instance of communications circuitry 110 for communicating over Wi-Fi or using Bluetooth®. In some embodiments, the same instance of communications circuitry 110 can be operative to provide for communications over several communications networks.

In one embodiment, the electronic device 100 may include an application to interface with at least one server thereby providing the electronic device 100 with the ability to create and present survey sessions 210. For example, through the application of the electronic device 100, the user can connect to a host server, website server, or the like. The host server can be any server that receives and transmits communication between the electronic device 100 and the host. For example, the host server can receive communication from the host and transmit the communication to the electronic device 100. The website server can be any server associated with a website associated with a survey session 210. In one embodiment, the website server communicates directly with the electronic device 100.

Communication between the electronic device 100 and the host server, the electronic device 100 and the website server, and the host server and the website server may be accomplished through any suitable network that may be provided by one or more communication interface, for example, WLAN, WAN, or LAN connection. Specifically, by way of example, the network may be a wireless internet connection established by way of the WLAN interface, a local area network connection established through the LAN interface, or a wide area network connection established by way of the WAN interface, which may include one of various WAN mobile communication protocols, such as a General Packet Radio Service (GPRS) connection, an EDGE connection (Enhanced Data rates for GSM Evolution connection), or a 3G connection, such as in accordance with the IMT-2000 standard. One or more of the data encryption techniques and security protocols (e.g., SSL or TSL protocols) may be further utilized in order to facilitate the secure transmission of the data (e.g. session information) from the electronic device 100 to the host server.

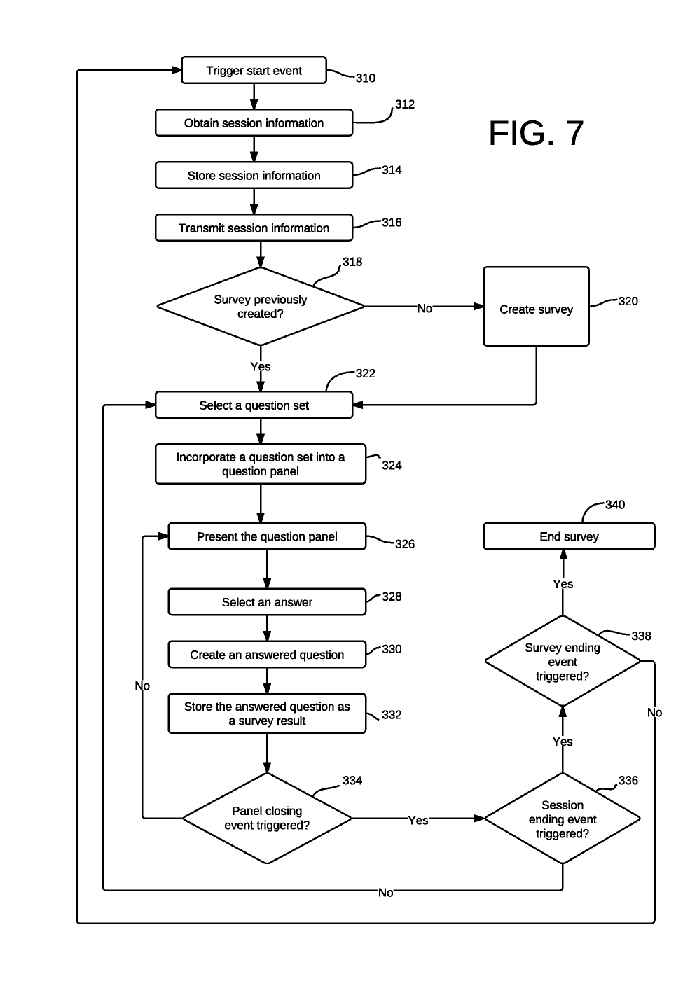

In one embodiment, the respondent interacts with a survey host via an interface of an electronic device 100. A survey host can be any means for associating a survey session 210 therewith, for example, a website, a software application, or the like. As shown in FIG. 7, during the respondent's interaction with the survey host, a start event is triggered 310 thereby beginning the survey 200 or survey session 210. The start event can be triggered 310 by the respondent engaging in a specific action with the interface of the survey host, for example, a mouse click, button push, keyboard stroke, the like, or re-engaging the survey host after a specified amount of time has transpired since the respondent previously visited or entered the survey host.

In one embodiment, once the start event is triggered 310, session information is obtained 312. The session information allows for the respondent to be identified and/or the respondent to be linked to the questions and/or answers of the survey 200. Session information can be a name, IP address, or any other unique identifier. Once session information is obtained 312, the session information is stored 314, thereby allowing for the session information to be retrieved at a future date. Data used with the system, for example, session information, question content 240, question sets 230, question panels 220, survey results 250, session ending events, or the like can be stored in a database including locally such as on a web browser, for example in a cookie, web storage, or the like, or on a software application, or on a host server, for example, in a secure storage 104, with the host server using scripting language. The host server can be any server that receives and transmits communication between the electronic device 100 and the host. The secure storage 104 can be, for example, without limitation, a MySQL database, XML files, or the like. Scripting language can be, for example, PHP, ASP, JavaScript, HyperText Markup Language (HTML), or the like.

In one embodiment, the application obtains the session information 312 and transmits the session information 316 from the electronic device 100 to a host server. For example, the host server can receive communication from the host and transmit the communication to the electronic device 100. In one embodiment, where the respondent is visiting a website, the application obtains the session information 312 from the website server and transmits the session information 316 to the host server. In one embodiment, where session information, for example, respondent's name and IP address, has been previously obtained and stored in the secured storage 104, respondent's identity can be obtained by comparing the current IP address associated with the electronic device 100 with the IP address stored in the secured storage 104.

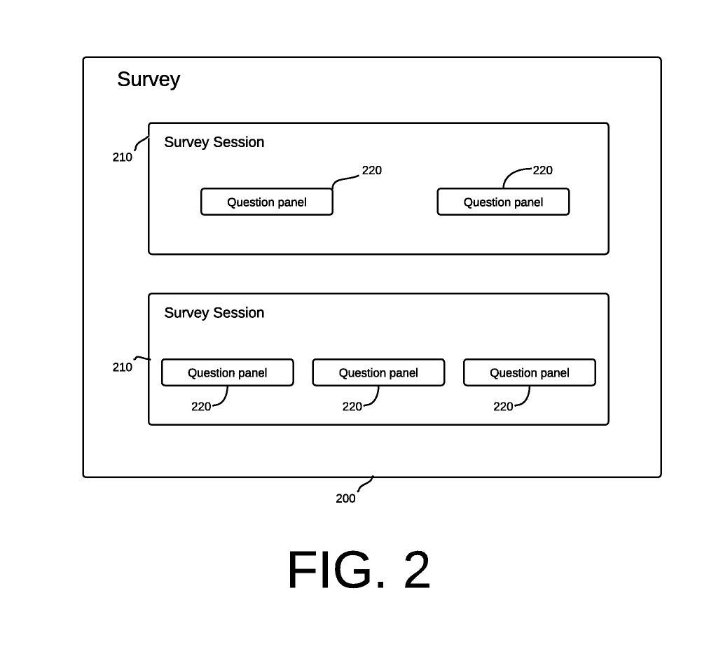

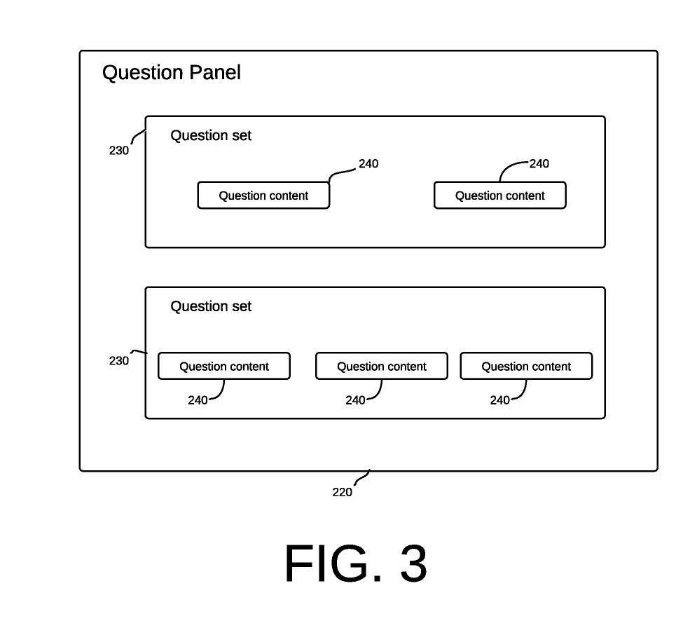

Once the session information is transmitted 316, the application determines whether a survey session 210 and thereby a survey 200 associated with the session information has been previously created 318. As shown in FIG. 2, the survey 200 can have a plurality of survey sessions 210. As shown in FIGS. 2 and 3, a survey session 210 can have at least one question panel 220 and thereby at least one question set 230. For example, a survey session 210 can have a plurality of question sets 230 and question panels 220. A survey 200 associated with session information has been previously created when a respondent associated with the session information has answered at least one question set 230.

In one embodiment, where a survey session 210 and thereby a survey 200 has not been previously created, a new survey 200 is created 320. In one embodiment, the application creates the new survey 200. A new survey 200 is created by the creation of at least one survey session 210. A survey session 210 is created by incorporating question content 240 into a question set 230. A question set 230 can be any combination of question content 240. Question content 240 can be any content typically found in a survey 200, for example, title, question, answer list, answer buttons, submit button, the like, or any combination thereof. In one embodiment, the step of selecting a question set 230 to be incorporated into a question panel 220 is performed 322. In one embodiment, the step of incorporating a question set 230 into a question panel 220 is performed 324. The question panel 220 can have at least one question set 230 of the survey session 210. For example, the question panel 220 can have two question sets 230 of the survey session 210.

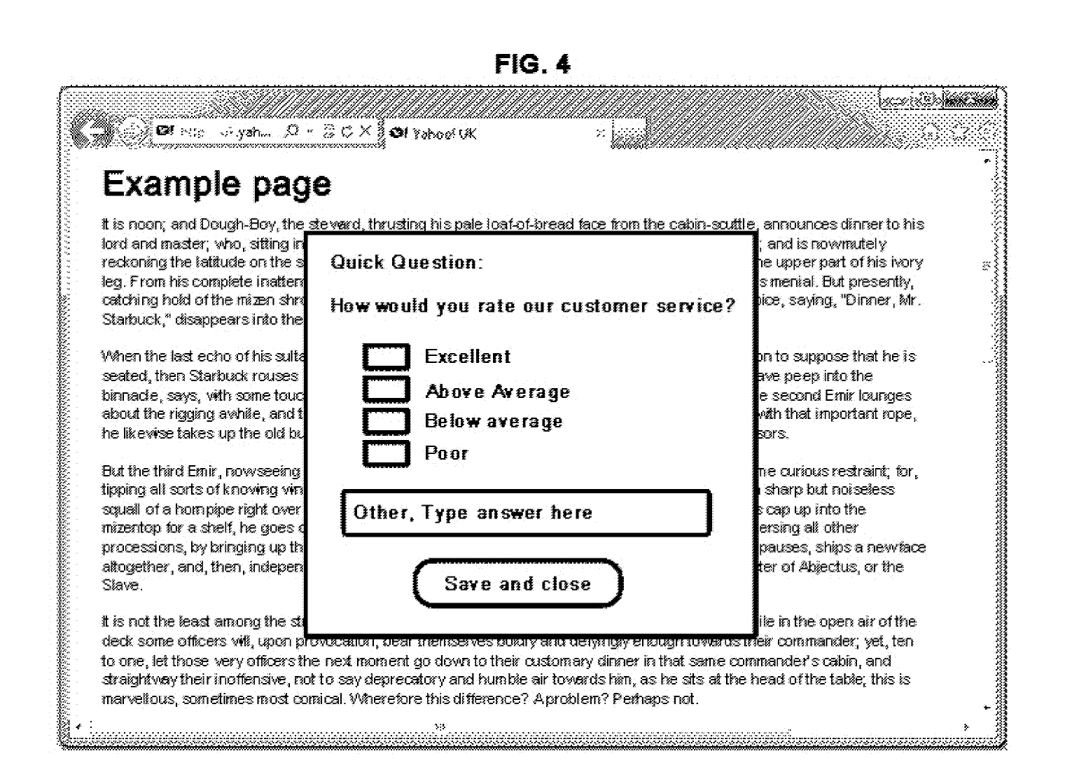

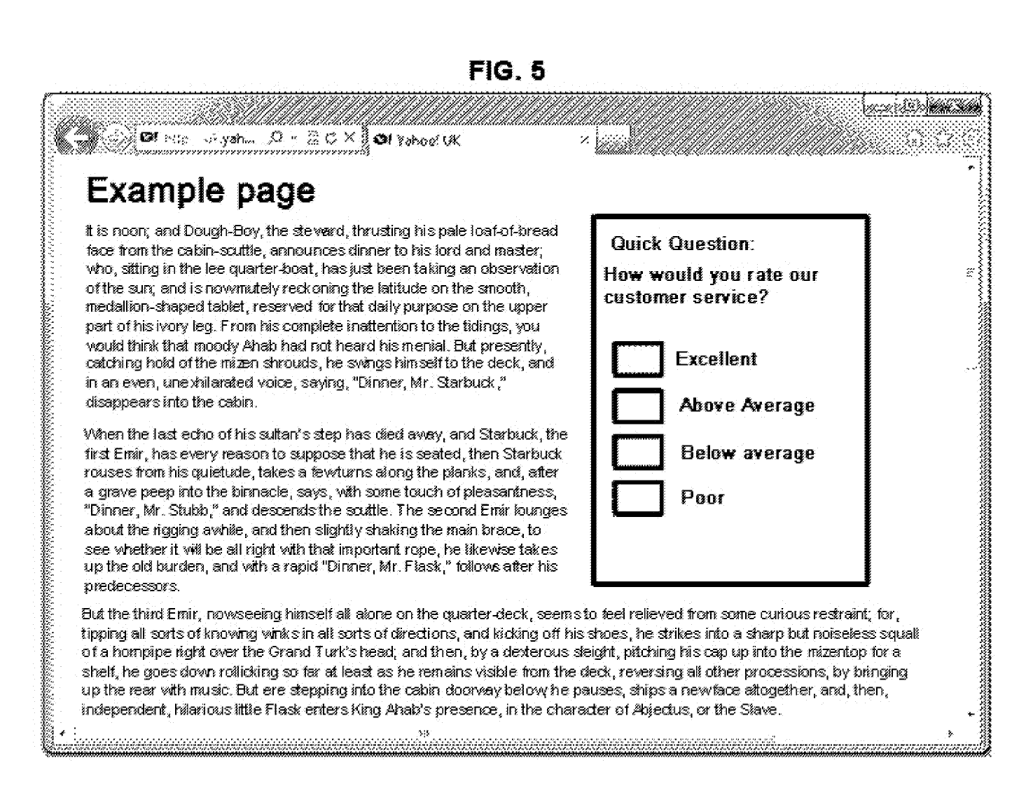

Once the question panel 220 is created, the question panel 220 is presented to the respondent 326. In one embodiment, the application presents the question panel 220 to the respondent. The question panel 220 can be presented to the respondent in any manner that allows the respondent to answer the question in the question panel 220. In one embodiment, as shown in FIG. 4, the question panel 220 is embedded into the webpage content. In one embodiment, as shown in FIG. 5, the question panel 220 is presented in a manner where the question panel 220 overlays the webpage content thereby obscuring the overlaid webpage content. Where the question panel 220 overlays the webpage content, the question panel 220 could be incorporated into an HTML popup overlay or a new web browser window.

In one embodiment, the question panels 220 presented to the respondent are selected in a variety of manners. For example, question panels 220 can be presented based on a predetermined sequence, based on a random selection of question panels 220 where the order of presenting the question panels 220 is random, based on a volume balancing sequence where question panels 220 are presented in order to obtain the same number of answers for each question panel 220, based on quota selection where a question panel 220 is presented to a predetermined number of respondents and once the question panel 220 is presented to a predetermined number of respondents, the question panel 220 is no longer presented to a respondent, or any combination thereof.

In one embodiment, the survey session 210 allows for branching logic where questions are not presented based on answers to previous questions. For example, where a first question presented to a respondent is “Do you exercise daily?” and the selected answer is “No,” a second question of “How long on average do you exercise for each day?” is not presented to the respondent.

In one embodiment, the survey session 210 provides for type restrictions that limit the type of data inputted by respondents to a desired format. For example, if a question asks for a phone number, the acceptable input may be limited to the form “###-###-####”.

Once the question panel 220 is presented to the respondent, the respondent conducts the survey session 210 by interacting with the interface of the electronic device 100. In one embodiment, where a survey session 210 has been created, the respondent continues with a previously created survey session 210. Here, a question panel 220 associated with the previously created survey session 210 is presented to the respondent.

The respondent begins a new survey session 210 or continues a previously created survey session 210 by selecting an answer 328 to the question presented in the question panel 220. Answers can be selected by the respondent interacting with the interface of the electronic device 100. In one embodiment, the respondent must select an answer before receiving access to a webpage.

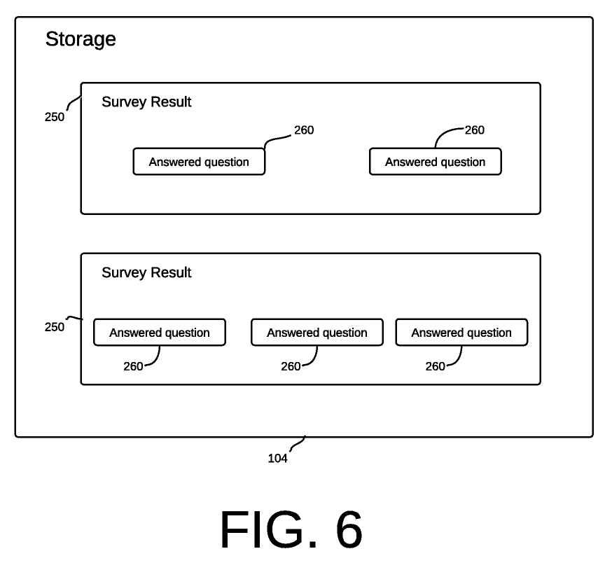

Once the respondent selects an answer, an answered question 260 is created 330 and stored 332 in the secured storage 104. An answered question 260 is at least one question and corresponding selected answer. In one embodiment, the application creates and stores the answered question 260. The time and date corresponding to the selected answers are stored with the answered question 260. The answered questions 260 are stored in the secured storage 104 as a survey result 250 where a survey result 250 is at least one answered question 260 whereby the selected answer of the answered questions 260 stored as the survey result 250 are provided by the same respondent, as shown in FIG. 6. For example, if a previous answered question 260 to a previously created survey session 210 associated with session information has been stored in the secured storage 104 as a survey result 250, a subsequent answered question 260, where the answer of the answered question 260 was selected by the same respondent as the previous answered question 260, will be stored in the secured storage 104 in the same survey result 250 thereby allowing the new answered question 260 to be associated with the previous answered question 260. Where an answered question 260 of a survey session 210 has not been previously stored in the secured storage 104 as a survey result 250, a new survey result 250 is created to store the answered question 260.

The question panel 220 is presented to the respondent until a panel closing event is triggered 334. A panel closing event is any event that closes a question panel 220. A panel closing event can be answering a question panel 220, closing the survey host, or the like.

Subsequent question panels 220 are presented to the respondent until a session ending event is triggered 336. A session ending event is an event that ends a survey session 210. The session ending event can be triggered by answering the final question of a survey session 210, responding to a previous question thereby rendering the respondent ineligible for further questioning, reaching a quota of answered questions 260, locating the respondent in an irrelevant geographic region, opting out of the survey session 210, or the like. The session ending event is stored in the secure storage 104.

Survey sessions 210 are presented to the respondent until a survey ending event is triggered 338. Once a survey ending event is triggered the survey ends 340. A survey ending event is an event that ends a survey 200. The survey ending event can be triggered by answering the final question of a survey 200, responding to a previous question thereby rendering the respondent ineligible for further questioning, reaching a quota of answered questions 260, locating the respondent in an irrelevant geographic region, opting out of the survey 200, or the like. The survey ending event is stored in the secure storage 104.

In one embodiment, the question panels 220 can be presented in a controlled manner. Here, the survey session 210 is presented to the respondent as a step function where at least one question panel 220 is presented to the respondent at one point in time, and at least one question panel 220 is presented to the respondent at a second point in time. In one embodiment, the application presents the question panels 220 to the respondent in a controlled manner. The presentation of the question panels 220 can be controlled, for example, based on a period of time the respondent remains on the survey host, the period of time that has transpired since the respondent triggered a start event, the amount of interaction by the respondent with the survey host, or the like.

For example, a subsequent question panel 220 can be presented to the respondent after the respondent has continued to interact with a survey host for 30 minutes since the last answered question 260 was created. Specifically, where the respondent has triggered a start event thereby beginning a survey session 210, a question panel 220 has been presented to the respondent, the respondent selects an answer to the question, 30 minutes has transpired since the respondent selected an answer to the question, and the respondent continues to interact with the survey host during the 30 minutes after the respondent selected an answer, a subsequent question panel 220 is presented to the respondent.

In another example, a subsequent question panel 220 can be presented to the respondent after three days have transpired since the respondent last visited the survey host. Specifically, where the respondent has activated a software application thereby triggering a start event, a question panel 220 has been presented to the respondent, the respondent has selected an answer to the question, the respondent has not interacted with or closed the software application, three days have transpired since the respondent has not interacted with or closed the software application, and the respondent then interacts with or activates a software application, a subsequent question panel 220 is presented to the respondent.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

What is claimed is:

1. A computer-implemented method for presenting a survey session to survey respondents, the method comprising:
a) triggering a start event,
b) obtaining, using a microprocessor, session information,
c) storing, using a microprocessor, the session information,
d) transmitting, using a microprocessor, the session information to a host server,
e) determining, using a microprocessor, whether a survey associated with the session information has been previously created,
f) selecting a question set to present to the respondent,
g) incorporating, using a microprocessor, a question set into a question panel,
h) presenting, using a microprocessor, the question panel to the respondent in a controlled manner,
i) selecting an answer to the question,
j) creating, using a microprocessor, an answered question,
k) storing, using a microprocessor, the answered question as a survey result,
l) repeating steps 1(G-J) until a panel closing event is triggered,
m) repeating steps 1(E-J) until a session ending event is triggered, and
n) repeating steps 1(A-J) until a survey ending event is triggered.

2. The method of claim 1 further comprising identifying, using a microprocessor, that a survey has not been previously created and creating, using a microprocessor, a survey.

3. The method of claim 1 wherein presenting the question panel is controlled dependent on a period of time the respondent remains on the survey host.

4. The method of claim 1 wherein presenting the question panel is controlled dependent on a period of time that has transpired since the respondent triggered a start event.

5. The method of claim 1 wherein presenting the question panel is controlled dependent on the amount of interaction by the respondent with the survey host.

6. The method of claim 1 wherein selecting a question panel to present to the respondent is based on a predetermined sequence.

7. The method of claim 1 wherein selecting a question panel to present to the respondent is based on random selection.

8. The method of claim 1 wherein selecting a question panel to present to the respondent is based on a volume balancing sequence.

9. The method of claim 1 wherein selecting a question panel to present to the respondent is based on quota selection.

10. An online survey system comprising:
a memory storage for maintaining a database
a processing unit coupled to the memory storage, wherein the processor is configured to:
generate question panels having question sets,
obtain session information,
store session information,
transmit the session information to a host server,
determine whether a survey associated with the session information has been previously created,
select a question set to present to the respondent,
incorporate a question set into a question panel,
present the question panel to the respondent in a controlled manner,
create an answered question, and
store the answered question as a survey result.

11. An online survey system of claim 10 wherein the presentation of the question panels to the respondent in a controlled manner is dependent on a period of time the respondent remains on the survey host.

12. An online survey system of claim 10 wherein the presentation of the question panels to the respondent in a controlled manner is dependent on a period of time that has transpired since the respondent triggered a start event.

13. An online survey system of claim 10 wherein the presentation of the question panels to the respondent in a controlled manner is dependent on the amount of interaction by the respondent with the survey host.
